(19) United States
(12) Patent Application Publication
(10) Pub. No.: US 2024/0324582 A1
(43) Pub. Date: Oct. 3, 2024

(54) METHOD AND SYSTEM FOR INVASIVE VINE REMOVAL FROM TREES

(71) Applicant: William Nicol Kittredge, Atlanta, GA (US)

(72) Inventor: William Nicol Kittredge, Atlanta, GA (US)

(21) Appl. No.: 18/127,464

(22) Filed: Mar. 28, 2023

(51) Int. Cl. A01M 21/02; B66D 1/12; B66D 1/24; B66D 1/36; B66D 1/46; B66D 1/58

(52) U.S. Cl. CPC A01M 21/02; B66D 1/12; B66D 1/24; B66D 1/365; B66D 1/46; B66D 1/58

(57) ABSTRACT

A system to perform vine removal includes a winch. The winch includes a mount configured to secure the winch to a stationary object. A drum is connected to the mount and configured to rotate bi-directionally. A cable is mounted to the drum such that rotation of the drum in a first direction releases the cable from the drum and rotation of the drum in a second direction spools the cable onto the drum. A securing implement is attached to an end of the cable. The securing implement is configured to attach to one or more vines such that operation of the drum in the second direction pulls the one or move vines toward the winch.

### BACKGROUND

In the United States, there are hundreds of invasive plant species that have been introduced into nature as a result of intentional planting, landscaping, illegal activity, accidental transportation, etc. Vines are a particular type of invasive plant that are known to attack and destroy trees. Invasive vines are a threat to trees and other native plants, as they compete with the native plants for nutrients, sunlight, water, and space. This can result in an area (e.g., forest) being overtaken and destroyed in a relatively short period of time. Invasive vines also create dangerous conditions in trees near residences and roadways as vines add significant weight to trees, and during periods of heavy rainfall saturated vines are commonly a meaningful contributor to fallen trees. Traditional methods of controlling invasive vines include the use of herbicides and manual removal with clippers and other hand tools.

### SUMMARY

An illustrative system to perform vine removal includes a winch. The winch includes a mount configured to secure the winch to a stationary object. A drum is connected to the mount and configured to rotate bi-directionally. A cable is mounted to the drum such that rotation of the drum in a first direction releases the cable from the drum and rotation of the drum in a second direction spools the cable onto the drum. A securing implement is attached to an end of the cable. The securing implement is configured to attach to one or more vines such that operation of the drum in the second direction pulls the one or move vines toward the winch.

In one embodiment, a motor is incorporated into the winch and configured to rotate the drum. In another embodiment, there is a fitting on the drum that mates with a tool such that the tool rotates the drum. In one embodiment, the system includes a computing device that enables user control of winch functions including tension control, spooling speed, and spooling direction. In another embodiment, the system includes a hand truck and the winch is attached to the hand truck.

In another embodiment, the drum comprises a first drum and the cable comprises a first cable, and the winch includes a second drum that acts as the mount, where the second drum includes a second cable to secure the winch to the stationary object. In such an embodiment, the system can also include a processor of a computing system. The processor is configured to control rotation of the first drum and the second drum to reposition the winch between the stationary object and the one or more vines. The processor can also be configured to determine that the first cable has been fully wound onto the first drum. In one embodiment, the processor repositions the winch by winding the second cable onto the second drum and releasing the first cable from the first drum. In another embodiment, the processor repositions the winch by winding the first cable onto the first drum and releasing the second cable from the second drum.

In another embodiment, the system includes a sensor or gauge configured to monitor a tension of the cable or a torque of the drum. The system can also include a processor of a computing system, where the processor compares the tension of the cable or the torque of the drum to a predetermined threshold value. In another embodiment, the processor generates an alert if the tension of the cable or the torque of the drum matches or exceeds the predetermined threshold value.

An illustrative method of removing invasive vines includes securing a winch to a stationary object, where the winch includes a drum that rotates bi-directionally, and where a cable is mounted to the drum such that rotation of the drum in a first direction releases the cable from the drum and rotation of the drum in a second direction spools the cable onto the drum. The method also includes attaching a securing implement to an end of the cable and to one or more vines that are attached to a tree. The method further includes operating the winch such that rotation of the drum in the second direction pulls the one or move vines toward the winch and removes the one or more vines from the tree.

The system can also include a computing device that includes a processor, where the processor enables user control of drum tension, drum spooling speed, and drum spooling direction. In one embodiment, the drum is a first drum and the cable is a first cable, and the system also includes a second drum that includes a second cable. In such an embodiment, the method includes securing the winch to the stationary object via the second cable. The method can also include controlling, by the processor, rotation of the first drum and the second drum to reposition the winch between the stationary object and the one or more vines. In one embodiment, the method includes determining, by the processor that the first cable has been fully wound onto the first drum, and the repositioning is performed responsive to the determination that the first cable has been fully wound onto the first drum. In another embodiment, repositioning the winch, by the processor, is performed by winding the second cable onto the second drum and releasing the first cable from the first drum.

The method can further include monitoring, by a sensor or gauge, a tension of the cable or a torque of the drum. In such an embodiment, the winch may include a computing system with a processor, and the method includes comparing, by the processor, the tension of the cable or the torque of the drum to a predetermined threshold value. The method can also include generating, by the processor, an alert if the tension of the cable or the torque of the drum matches or exceeds the predetermined threshold value.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A is a block diagram of a vine removal system in accordance with an illustrative embodiment.

FIG. 1B depicts a native tree with invasive vines, a securing implement attached to the vines and to a winch cable in accordance with an illustrative embodiment.

FIG. 1C depicts the winch secured to a stable structure (e.g., tree) in accordance with an illustrative embodiment.

FIG. 1D depicts a winch system mounted between invasive vines and an anchor tree in accordance with an illustrative embodiment.

FIG. 1E depicts a hand truck winch system in accordance with an illustrative embodiment.

FIG. 2 is a block diagram of a vine removal system with a dual drum winch in accordance with an illustrative embodiment.

FIG. 3 is a flow diagram depicting operations performed by a vine removal system in accordance with an illustrative embodiment.

FIG. 4 is a block diagram of a computing device to control the vine removal system in accordance with an illustrative embodiment.

Other principal features and advantages of the invention will become apparent to those skilled in the art upon review of the following drawings, the detailed description, and the appended claims.

### DETAILED DESCRIPTION

Traditional techniques for removing invasive vines include the use of herbicides, which can be harmful to native plant species, dangerous for users to apply, and overall detrimental to the environment. Even after herbicides are successfully applied, dead and/or dying vines may stay attached to trees for months or years before eventually detaching from tree trunks and branches. In the meantime, vines continue to suffocate the tree, blocking both air and light from the tree bark. Manual vine removal is also practiced. Manual vine removal involves pulling out invasive vines by hand, and often involves climbing trees to access the vines. As a result, such manual vine removal is very labor intensive, time intensive, and is inherently dangerous due to the climbing involved. Thus, there is a need for a vine removal system that is safe for the environment, promotes the overall health of the tree, and is safe and efficient for the user to effectively remove vines. Described herein are methods and systems for the removal of invasive vines. In an illustrative embodiment, the proposed vine removal system includes a winch that is designed to attach to one or more securing implements (e.g., rigging straps, tree savers, brush grubbing chains, etc.) that quickly secure to ground level vines and pull the vines away from a tree trunk/canopy or other structure upon which the vines have grown and attached themselves.

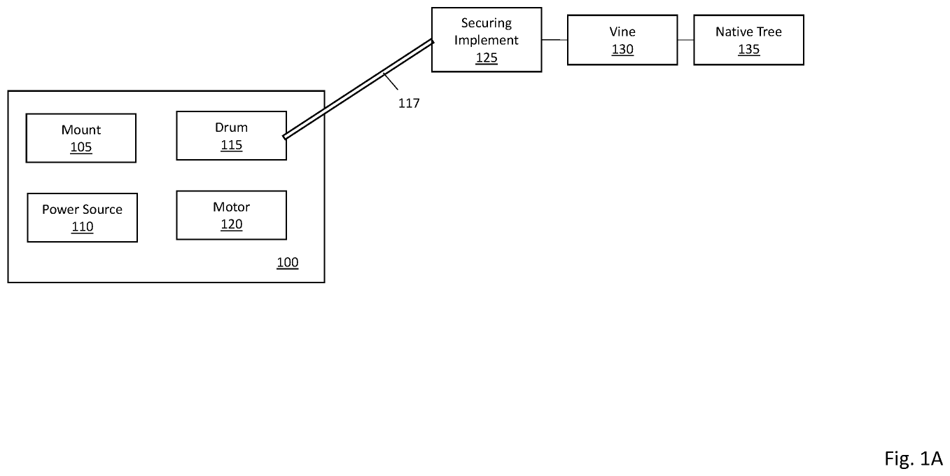

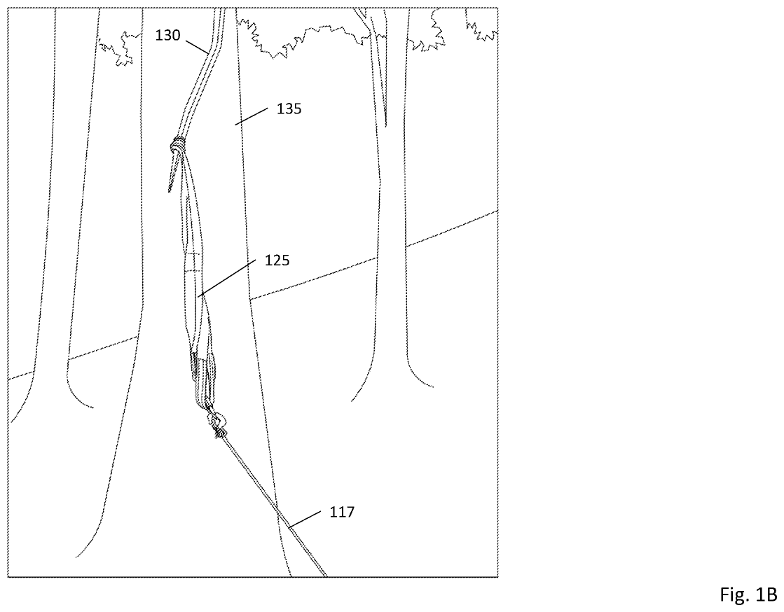

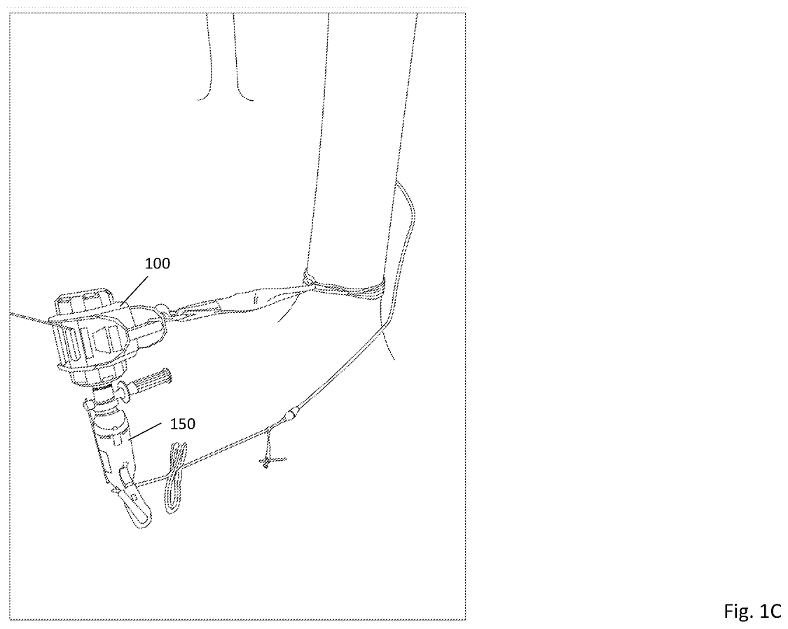

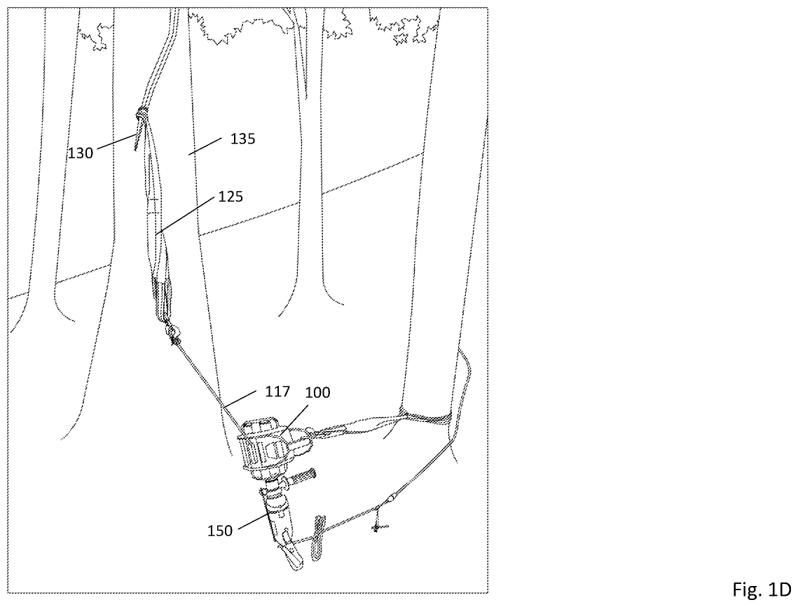

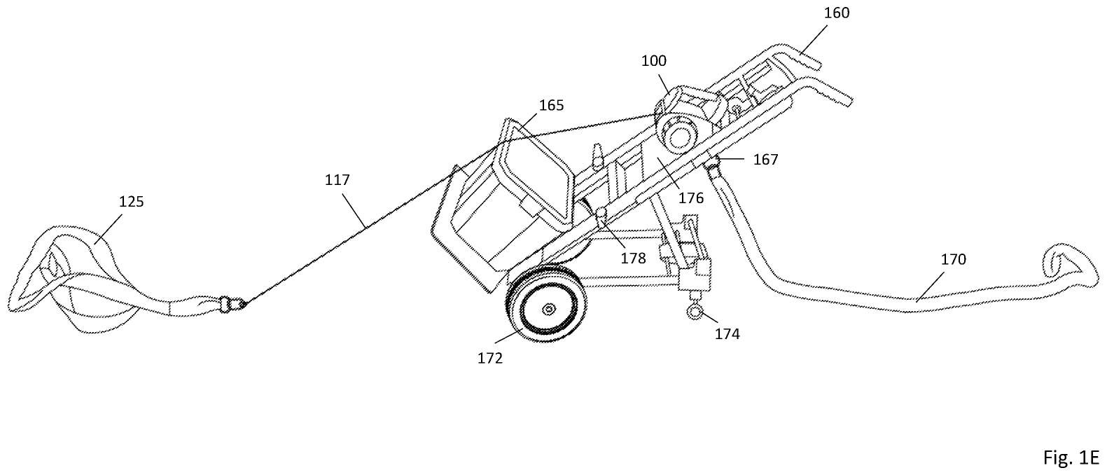

FIG. 1A is a block diagram of a vine removal system in accordance with an illustrative embodiment. The vine removal system includes a winch 100 that is attached to a vine 130 that has grown onto a native tree 135. Alternatively, instead of a native tree 135, the vine 130 can be attached to another structure such as a building or other plant. The winch 100 includes a mount 105, a power source 110, a drum 115, and a motor 120. In alternative embodiments, the winch 100 can include fewer, additional, and/or different components. Attached to the drum 115 of the winch 100 is a cable 117. A securing implement 125 is attached to the end of the cable 117. In an illustrative embodiment, the cable 117 is secured to the vine 130 via the securing implement 125, which can be a D-shackle, a tree saver, a grubbing chain, a grubbing clamp, etc. In an embodiment where additional mechanical advantage is needed, the cable 117 may be routed through a pulley or snatch block which is mounted to a secondary tree (or other anchor) with a tree saver or other securing implement.

FIG. 1B depicts a native tree 135 with invasive vines 130, a securing implement 125 attached to the vines 130 and to a winch cable 117 in accordance with an illustrative embodiment. As shown, the securing implement 125 is in the form of a tree saver strap that includes a first looped end and a second looped end. The first looped end of the tree saver strap is secured to the vines 130 and the second looped end of the tree saver strap is attached to a D-ring (or shackle or carabiner) that attaches to a hook at the end of the cable 117 of the winch.

In an illustrative embodiment, the winch 100 is mounted to a stable structure that has sufficient mass and/or strength to allow the winch to remain relatively stationary during operation. The stable structure to which the winch 100 is mounted can be a tree, a vehicle (e.g., all-terrain vehicle, sport utility vehicle, truck, etc.), a post, a wall of a building, a roof of a building, a ground anchor, etc. The mount 105 is used to secure the winch 100 to the stable structure. In one embodiment, the mount 105 can be a plate with through holes such that the winch 100 can be bolted or screwed to a vehicle, post, or other stable structure. The mount 105 can alternatively be in the form of a shackle or other connector (e.g., D-ring, carabiner, etc.) or portion of the winch 100 (e.g., a loop, hook, or other connector formed on a chassis of the winch 100) that connects to a mounting line which is secured to the stable structure. For example, the stable structure can be a tree and the mounting line can be a tree saver strap, which is a rigging/towing strap formed with a loop at each end. Alternatively, the mounting line can be in the form of a rope, metal cable, etc. In an alternative embodiment, any other type of mount may be used.

FIG. 1C depicts the winch 100 secured to a stable structure (e.g., tree) in accordance with an illustrative embodiment. As shown, a drill 150 is attached to the winch 100 and can be used to power the winch 100. Alternatively, a battery or other power source may be used. FIG. 1D depicts a winch system mounted between invasive vines and an anchor tree in accordance with an illustrative embodiment.

Referring again to FIG. 1A, in one embodiment, the power source 110 of the winch 100 can be a dedicated battery that is incorporated into the winch 100 and that provides power to the motor 120. Alternatively, the winch 100 may include an electrical plug such that an electrical outlet can be used to power the motor 120. In one embodiment, the winch 100 can be powered by a handheld drill that mounts to the drum 115, as shown in FIGS. 1C and 1D. In such an embodiment, the handheld drill can be the power source 110 (e.g., drill battery or drill electrical plug) and can also include the motor 120 such that the winch 100 is essentially formed as the drum 115 and the cable 117 connected to the mount 105.

The drum 115 can be any type of drum known in the art. In an illustrative embodiment, the drum 115 is in the form of a spool onto which the cable 117 is wound and unwound. The drum 115 connects to the motor 120 via one or more gears that translate motor rotation into rotation of the drum 115. The gears can be planetary gears, worm gears, spur gears, etc. The drum 115 is sized to receive a desired amount of the cable 117. For example, the drum 115 can be sized to receive 25 feet of cable, 50 feet of cable, 100 feet of cable, 300 feet of cable, etc. The cable 117 can be made from rope, wire, synthetic fiber, etc.

The motor 120 can be a permanent magnet direct current (DC) motor or a series wound DC motor in one embodiment. Alternatively, an AC motor can be used instead of the DC motor. In an illustrative embodiment, the motor 112 can include a first set of coils, called an armature, inside a second set of coils or a set of permanent magnets, called the stator. The stator produce a magnetic field that causes the rotor (or armature) to rotate when an electric current flows through it. Applying a voltage to the coils produces a torque in the armature, resulting in motion. The motor 120 can also include one or more solenoids or other switches that control activation of the motor 120 in either a forward direction (i.e., unspooling the cable 117 from the drum 115) or reverse direction (i.e., winding the cable 117 onto the drum 115) responsive to a received electrical signal. As discussed above, a dedicated motor such as the motor 120 may not be used in embodiments in which the winch 100 is operated by a drill or other tool. In another alternative embodiment, the winch 100 can be hand powered (e.g., via a crank/handle attached to the drum) such that the power source 110 and the motor 120 are not included. In an alternative embodiment, the winch 100 can be in the form of a hand-operated come-along tool.

FIG. 1E depicts a hand truck winch system in accordance with an illustrative embodiment. In this embodiment, which was designed for greater portability and ease of use, the winch 100 is mounted on a heavy-duty hand truck 160 that is customized for vine removal. This embodiment enables the vine removal system to 1) be transported from tree to tree in an efficient manner, and 2) stand upright while in use, with openings on the front and back for operation of the winch cable 117. The heavy-duty hand truck 160 includes a built-in storage container 165 that is designed to hold all associated implements, including tree savers (e.g., the tree saver 125), shackles, brush grubbers, power cords, a drill (if used to operate the winch), a battery to operate the winch, quick links, etc.

As shown, the heavy-duty hand truck 160 includes a mount 167 that allows the heavy-duty hand truck to be secured to a stationary object (e.g., a tree, a vehicle, a rock, etc.) through the use of a strap or other implement, such as the strap 170. The mount 167 is shown in the form of a eye bolt mounted to hand truck behind the winch 100. In alternative embodiments, a different type/shape of mount may be used, and the mount 167 may be positioned elsewhere on the heavy-duty hand truck 160. In another embodiment, the heavy-duty hand truck can include a plurality of mounts to secure the hand truck to one or more stationary objects such that the hand truck remains stationary while the winch 100 is used to remove vines from trees.

The heavy-duty hand truck 160 also includes an off-road wheel system that includes a primary set of wheels 172 that are used to maneuver the heavy-duty hand truck 160 over rough terrain that may be encountered in the woods, on logging roads, etc. The heavy-duty hand truck also includes a secondary set of wheels 174 that are used to support and balance the hand truck. The heavy-duty hand truck 160 is formed in part from left and right supports that provide structural support to the truck and extend into handles that allow a user to move the hand truck. A mounting plate 176 is positioned between these left and right supports and used to support the winch 100, which can be mounted via bolts, welds, straps, etc. Also mounted to each of the left and right supports is one or more pegs (or hooks) 178, which can be used to hold straps, extension cords, etc.

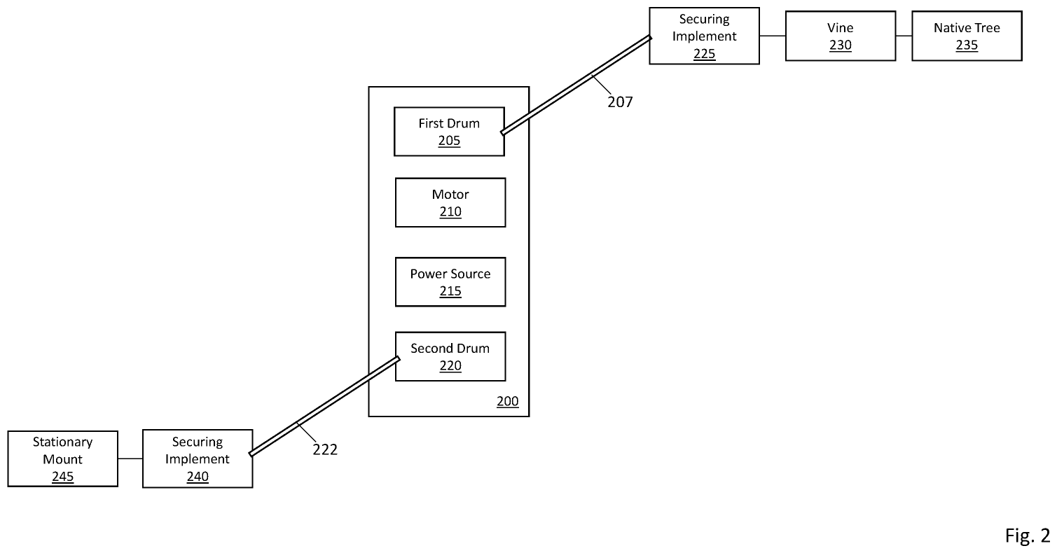

FIG. 2 is a block diagram of a vine removal system with a dual drum winch 200 in accordance with an illustrative embodiment. The dual drum winch 200 includes a first drum 205, upon which a first cable 207 is mounted such that the first cable 207 winds onto and unwinds off of the first drum 205. The first cable 207 is attached to a securing implement 225 (e.g., shackle, tree saver strap, chain, clamp, etc.) that attaches to a vine 230 that is attacking a native tree 235. The dual drum winch 200 also includes a motor 210 and a power source 215, which can be any type of motor/power source described herein, including one or more drills or hand cranks that mount to the dual drum winch 200. The dual drum winch 200 also includes a second drum 220, upon which a second cable 222 is mounted such that the second cable 222 winds onto and unwinds off of the second drum 220. The second cable 222 is attached to a securing implement 240 (e.g., shackle, tree saver strap, chain, clamp, etc.) that attaches to a stationary mount 245. The stationary mount 245 can be a tree, a vehicle, a ground anchor, a building, etc.

In use, the dual drum winch 200 can be suspended between the vine 230 and the stationary mount 245, and the dual drum winch 200 can automatically adjust its position in one embodiment. For example, in one embodiment, the dual drum winch 200 includes a computer system (described below) incorporated therein, and the computer system is used to automatically control winding/unwinding of the cables off of both the first drum 205 and the second drum 220. In communication with the computer system are one or more sensors that monitor the amount of cable emitted from each of the winch drums. The sensor(s) can monitor the amount of rotation of each drum, and the computer system can use the amount of rotation (e.g., number of turns) to determine the length of cable that extends from each drum at any given time. Alternatively, a different type of sensor(s) may be used to monitor the cables. The computer system can use the sensed information along with a known total length of each cable to control the system and ensure that both winches continue to operate until the vines are removed.

For example, if the winch pulls the vine 230 all the way up to the first drum 205 and can pull it no further, the computer system can detect such a scenario and automatically control the second drum 220 to reposition the winch and continue pulling the vine. As another example, the second drum 220 can draw in the cable 222 while the first drum 205 releases the cable 207 until the dual drum winch 200 is repositioned and the first drum 205 can again pull on the vine 230. In one embodiment, if the vine 230 is difficult to pull off of the native tree 235, the computer system can activate both the first drum 205 and the second drum 220 to jointly draw in their respective cables (207 and 222) to provide additional pulling force.

In one embodiment, the computer system can monitor a tension (or pulling force) being exerted through the first cable 207 and/or the second cable 222. In an illustrative embodiment, the tension can be monitored by determining the amount of torque being exerted by the drum(s). For example, a torsion sensor can be incorporated into the winch and used to monitor torque. Alternatively, the pulling force on the cable(s) can be monitored using a force meter (or gauge), which is incorporated into the winch 200. The computer system can be used to control the tension (or force) to avoid damage to the native tree 235 and/or to the winch itself. For example, some trees have tender bark that is unable to sustain high pulling forces to remove vines. In such a scenario, the user can set a force threshold that is not to be exceeded by the winch. The force threshold can be in Newtons, Newton-meters, etc. depending on how the tension is being monitored by the computer system. If the tension is determined to exceed the predetermined force threshold, the processor can generate an alert to warn the user that damage to the tree and/or winch system is possible. The alert can be an audio alert (beep, buzz, or alarm emitted through a speaker), an automatic shutdown of the winch by the processor, a visual alert (one or more lights on a display), a remote alert (e.g., text message) sent to a user device, etc.

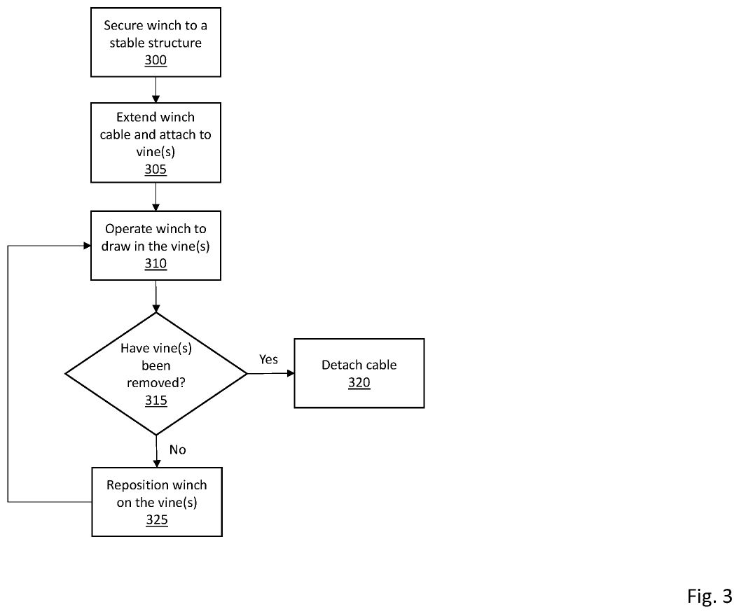

FIG. 3 is a flow diagram depicting operations performed by a vine removal system in accordance with an illustrative embodiment. In alternative embodiments, fewer, additional, and/or different operations may be performed. Also, the use of a flow diagram is not meant to be limiting with respect to the order of operations performed. In an operation 300, the winch is secured to a stable structure. In an operation 305, the winch cable is extended from the winch drum and attached to one or more vines. In an operation 310, the winch is operated to draw in the cable and remove the vine(s) from the tree trunk and/or canopy. Specifically, the drum of the winch is rotated such that the cable and vine(s) attached thereto are drawn toward the drum of the winch, creating tension on the cable which causes the vines to release from the tree.

In an operation 315, a determination is made regarding whether the vine(s) have been removed. If it is determined that the vine(s) have been removed in the operation 315, the cable is detached in an operation 320 and the process ends. If it is determined in the operation 315 that the vine(s) have not been removed, the winch is repositioned on the vine(s) in an operation 325, and the process continues again at the operation 310 (i.e., operation of winch) until another determination is made in the operation 315. In an illustrative embodiment, repositioning the winch on the vine(s) can include removing the securing element (or other connector) that attaches the cable to the vine(s) and reattaching the securing element (or other connector) further up on the vine(s) so that more of the vine(s) can be removed by subsequent pulling. Alternatively, if it is determined that a different pulling angle is desired, the securing implement may be left connected to the vines and the mount may be relocated to an alternate tree, or any other available stable structure. Alternatively, if it is determined that additional mechanical advantage is needed to successfully pull the vines, the winch cable may be routed through a snatch block (or pulley alternatively) which utilizes an additional tree saver to connect to a secondary tree or any other available stable structure that can act as an anchor.

As discussed above, certain trees have a more delicate bark layer that may be damaged if too much force is utilized to pull the vine from the tree. In these cases, a tension regulator can be added to the vine removal system to ensure that the winch cable tension does not exceed a predetermined threshold. Additionally, as discussed with reference to FIG. 2, in some embodiments, repositioning of the winch can be performed automatically by a computer system using dual drums of the winch.

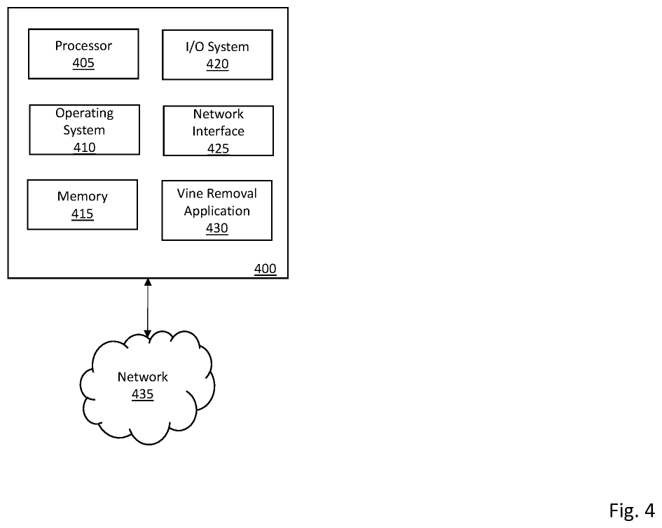

FIG. 4 is a block diagram of a computing device 400 to control the vine removal system in accordance with an illustrative embodiment. The computing device 400 is in communication with a network 435. The computing device 400 can be in direct or indirect (e.g., through the network 435) communication with a user device, such as a smart phone, laptop computer, etc. The computing device 400, which can act as a controller for the system, includes a processor 405, an operating system 410, a memory 415, an input/output (I/O) system 420, a network interface 425, and a vine removal application 430. In alternative embodiments, the computing device 400 may include fewer, additional, and/or different components. In an illustrative embodiment, at least a portion of the computing device 400 is incorporated into the winch that is used to form the vine removal system. In another embodiment, the computing device 400 can be independent of the winch, and used to remotely control the winch and its components.

The components of the computing device 400 communicate with one another via one or more buses or any other interconnect system. The computing device 400 can be any type of networked computing device. In an illustrative embodiment, the computing device 400 can be a dedicated device that is incorporated into the winch described herein. Alternatively, the computing device 400 can be a device that is used to remotely control the winch, such as a tablet, a cell phone, a desktop computer, etc.

The processor 405 can be in electrical communication with and used to control any of the system components described herein. The processor 405 can be any type of computer processor known in the art, and can include a plurality of processors and/or a plurality of processing cores. The processor 405 can include a controller, a microcontroller, an audio processor, a graphics processing unit, a hardware accelerator, a digital signal processor, etc. Additionally, the processor 405 may be implemented as a complex instruction set computer processor, a reduced instruction set computer processor, an x86 instruction set computer processor, etc. The processor 405 is used to run the operating system 410, which can be any type of operating system.

The operating system 410 is stored in the memory 415, which is also used to store programs, user data, network and communications data, peripheral component data, the vine removal application 430, and other operating instructions. The memory 415 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 415 can be in the cloud to provide cloud storage for the system. Similarly, in one embodiment, any of the computing components described herein (e.g., the processor 405, etc.) can be implemented in the cloud such that the system can be run and controlled through cloud computing.

The I/O system 420 is the framework which enables users and peripheral devices to interact with the computing device 400. The I/O system 420 can include one or more displays (e.g., light-emitting diode display, liquid crystal display, touch screen display, etc.) that allow the user to view settings and controls, indicator lights, switches, etc. that allow the user to interact with and control the computing device 400 and components connected thereto. The I/O system 420 also includes circuitry and a bus structure to interface with peripheral computing devices such as power sources, USB devices, data acquisition cards, peripheral component interconnect express (PCIe) devices, serial advanced technology attachment (SATA) devices, high definition multimedia interface (HDMI) devices, proprietary connection devices, etc.

The network interface 425 includes transceiver circuitry (e.g., a transmitter and a receiver) that allows the computing device to transmit and receive data to/from other devices such as a user device, other remote computing systems, servers, websites, etc. The network interface 425 enables communication through the network 435, which can be one or more communication networks. The network 435 can include a cable network, a fiber network, a cellular network, a wi-fi network, a landline telephone network, a microwave network, a satellite network, etc. The network interface 425 also includes circuitry to allow device-to-device communication such as Bluetooth®: communication.

The vine removal application 430 can include software and algorithms in the form of computer-readable instructions which, upon execution by the processor 405, performs any of the various operations described herein such as controlling an amount of cable that is drawn onto or extended from a first drum of the winch, controlling an amount of cable that is drawn onto or extended from a second rum of the winch, controlling a rate at which the drum rotates, controlling a direction in which the drum rotates, controlling the first drum and/or second drum to reposition the winch, automatically regulating tension on the cable based on a predetermined threshold, generating a user alert responsive to cable tension that is too high or too low, controlling and operating sensors (e.g., rotational sensors, torque sensors, etc.), etc. The vine removal application 430 can utilize the processor 405 and/or the memory 415 as discussed above. In an alternative implementation, the vine removal application 430 can be remote or independent from the computing device 400, but in communication therewith.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system to perform vine removal, the system comprising:
a winch, wherein the winch includes:
a mount configured to secure the winch to a stationary object;
a drum connected to the mount, wherein the drum is configured to rotate bi-directionally; and
a cable mounted to the drum such that rotation of the drum in a first direction releases the cable from the drum and rotation of the drum in a second direction spools the cable onto the drum; and
a securing implement attached to an end of the cable, wherein the securing implement is configured to attach to one or more vines such that operation of the drum in the second direction pulls the one or move vines toward the winch.

2. The system of claim 1, further comprising a portable hand truck, wherein the winch is attached to the hand truck.

3. The system of claim 1, further comprising a fitting on the drum that mates with a tool such that the tool rotates the drum.

4. The system of claim 1, further comprising a computing device that enables user control of winch functions including tension control, spooling speed, and spooling direction.

5. The system of claim 1, wherein the drum comprises a first drum and the cable comprises a first cable, and further comprising a second drum that acts as the mount, wherein the second drum includes a second cable to secure the winch to the stationary object.

6. The system of claim 5, further comprising a processor of a computing system, wherein the processor is configured to control rotation of the first drum and the second drum to reposition the winch between the stationary object and the one or more vines.

7. The system of claim 6, wherein the processor is configured to determine that the first cable has been fully wound onto the first drum.

8. The system of claim 6, wherein the processor repositions the winch by winding the second cable onto the second drum and releasing the first cable from the first drum.

9. The system of claim 6, wherein the processor repositions the winch by winding the first cable onto the first drum and releasing the second cable from the second drum.

10. The system of claim 1, further comprising a sensor or gauge configured to monitor a tension of the cable or a torque of the drum.

11. The system of claim 10, further comprising a processor of a computing system, wherein the processor compares the tension of the cable or the torque of the drum to a predetermined threshold value.

12. The system of claim 11, wherein the processor generates an alert if the tension of the cable or the torque of the drum matches or exceeds the predetermined threshold value.

13. A method of removing invasive vines, the method comprising:
securing a winch to a stationary object, wherein the winch includes a drum that rotates bi-directionally, and wherein a cable is mounted to the drum such that rotation of the drum in a first direction releases the cable from the drum and rotation of the drum in a second direction spools the cable onto the drum;
attaching a securing implement to an end of the cable and to one or more vines that are attached to a tree; and
operating the winch such that rotation of the drum in the second direction pulls the one or move vines toward the winch and removes the one or more vines from the tree.

14. The method of claim 13, further comprising a computing device that includes a processor, wherein the processor enables user control of drum tension, drum spooling speed, and drum spooling direction.

15. The method of claim 13, wherein the drum comprises a first drum and the cable comprises a first cable, and further comprising a second drum that includes a second cable, and further comprising securing the winch to the stationary object via the second cable.

16. The method of claim 15, wherein the winch includes a computing system with a processor, and further comprising controlling, by the processor, rotation of the first drum and the second drum to reposition the winch between the stationary object and the one or more vines.

17. The method of claim 16, further comprising, determining, by the processor that the first cable has been fully wound onto the first drum, and wherein the repositioning is performed responsive to the determination that the first cable has been fully wound onto the first drum.

18. The method of claim 16, further comprising repositioning the winch, by the processor, by winding the second cable onto the second drum and releasing the first cable from the first drum.

19. The method of claim 13, further comprising monitoring, by a sensor or gauge, a tension of the cable or a torque of the drum.

20. The method of claim 19, wherein the winch includes a computing system with a processor, and further comprising:
comparing, by the processor, the tension of the cable or the torque of the drum to a predetermined threshold value; and
generating, by the processor, an alert if the tension of the cable or the torque of the drum matches or exceeds the predetermined threshold value.
